(19) United States
(12) Patent Application Publication
(10) Pub. No.: US 2009/0011801 A1
(43) Pub. Date: Jan. 8, 2009

(54) Method for Power-Saving Operation of Communication Terminals in a Communication System

(75) Inventors: Hans Van Der Schaar, Breda (NL); Kees Geerts, Dongen (NL)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 12/160,159

(22) PCT Filed: Mar. 20, 2007
(86) PCT No.: PCT/EP07/52614

§ 371 Date: Jul. 7, 2008

(30) Foreign Application Priority Data
Mar. 28, 2006 (DE) 10 2006 014 680.8

(51) Int. Cl. H04M 1/73; H04M 11/00

(52) U.S. Cl. 455/574

(57) ABSTRACT

The invention proposes a method for power-saving operation of communication terminals in a communication system, particularly in a wireless communication system, where a central station in the communication system takes a user input as a basis for prompting a change in an operating state of the communication terminals in the communication system which is characterized by the power consumption. Preferably, the method is used in wireless conference systems, with the communication terminal being in the form of a participant unit and/or chairman unit.

### PRIOR ART

The invention relates to a method for a power-saving operation of communication terminals in a communication system, particularly in a wireless communication system; a switching center and a communication terminal; and their use in a conference system, particularly in a wireless conference system.

The German patent application DE 198 60 868 A1 has disclosed a method for a current-saving operation of communication terminals in a communication system. DE 198 60 868 A1 has also disclosed that a switching center switches the communication terminals into an active mode. It is also known for the switching center to send a report that a communication terminal can continue to remain in a sleep mode.

### DISCLOSURE OF THE INVENTION

### Advantages of the Invention

The method described below for a power-saving operation of communication terminals in a communication system according to the independent claim 1 has the advantage that the power consumption of communication terminals is reduced and therefore the availability of communication terminals is increased. On the other hand, the method has the advantage that a normal operating mode with the full functionality of the communication terminals can be quickly produced. This is advantageously achieved in that it is possible, by means of an input of a user of the communication system, to change an operating mode of the communication terminals, which mode is characterized by the power consumption. In this context, it is particularly advantageous that the switching center switch the communication terminals into the power-saving standby mode since this permits the communication terminals to be switched into a sleep mode centrally. It is particularly advantageous that these changes of the operating mode characterized by the power consumption occur simultaneously, i.e. at the same time, for all of the communication terminals connected to the communication system.

It is particularly advantageous if the user input occurs directly at the switching center since this permits the method to be carried out in a particularly rapid fashion. The user input on a computer connected to the switching center has the advantage that the method can be carried out remotely from a workplace situated elsewhere.

It is advantageous that the user input occurs in a communication terminal, with the message sent from the communication terminal to the switching center prompting the switching center to switch the other communication terminals into a power-saving standby mode, since this assures that the entire communication system can also be switched into a power-saving mode remotely by means of individual communication terminals, without this having to be carried out through a manual intervention at the switching center.

It is particularly advantageous that the user input occurs in a communication terminal, with the message sent from the communication terminal to the switching center prompting the switching center to switch the other communication terminals from a power-saving standby mode into a normal operating mode, since this assures that each communication terminal is able to switch the entire communication system back into normal mode as needed.

The above-mentioned advantages of the method also apply correspondingly to the switching center according to the invention and to the communication terminal according to the invention.

It is particularly advantageous to use the switching center and the communication terminal with the method according to the invention in a wireless communication system in which the communication terminal is embodied in the form of a participant unit or a chairperson unit, since in conference systems on the one hand, a long standby phase of the wireless participant units and the wireless chairperson unit results in a high acceptance of the conference system.

Other advantages ensue from the following description of exemplary embodiments with reference to the drawings and from the dependent claims.

### DRAWINGS

The invention will be explained in greater detail below in conjunction with the embodiment shown in the drawings.

FIG. 1 is a block circuit diagram,

FIG. 2 is a phase diagram,

FIG. 3 is a flowchart.

### DESCRIPTION OF THE EXEMPLARY EMBODIMENTS

In the following, a description is given of a method for a power-saving operation of communication terminals in a communication system, particularly in a wireless communication system, in which a switching center of the communication system, as a function of a user input, prompts a change in an operating mode of the communication terminals of the communication system, which mode is characterized by the power consumption. In the preferred exemplary embodiment described below, the method is used in wireless conference systems and the communication terminal is embodied in the form of a participant unit and/or a chairperson unit.

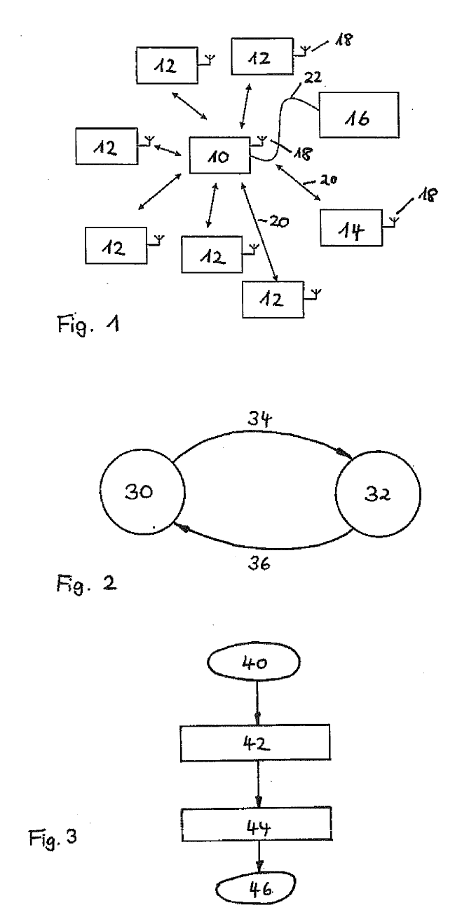

FIG. 1 is a block circuit diagram of a wireless conference system of the preferred exemplary embodiment, including a switching center 10, a plurality of participant units 12, and a chairperson unit 14 as communication terminals. In this context, conference systems are apparatus that provide technical means to assist participants in discussions, meetings, and conferences. Participant units 12 and also the chairperson units 14 are each provided with a microphone and a speaker as basic equipment. Participants transmit their spoken messages by pressing a microphone button situated on the participant unit 12. The microphone of the participant unit 12 transmits the spoken contribution of a participant to the speakers of the other participant units 12 of the rest of the conference participants. The chairperson operates a chairperson unit 14, which makes it possible for him or her to lead and control the course of the event. To this end, the chairperson unit 14 offers the chairperson the possibility, for example, of registering spoken messages, but also of interrupting the rest of the participants by actuating a priority button on the chairperson unit 14. In other embodiments of the conference system, the participant units 12, interacting with the switching center 10 and the chairperson unit 14, permit electronic voting, for example, and operation with interpreters. In the preferred exemplary embodiment, the conference system is embodied as a wireless communication system. The communication terminals embodied in the form of participant units 12 and the chairperson unit 14 are connected to the switching center 10 via a wireless connection 20, which is embodied as a radio connection in the current exemplary embodiment. In addition to proprietary protocols, the communications protocol of the radio connection can also use standardized communication protocols such as WLAN (wireless local area network) and Bluetooth. To this end, the participant units 12, the chairperson unit 14, and the switching center 10 are each equipped with an antenna 18. In the preferred exemplary embodiment, the participant units 12 and the chairperson unit 14 are battery-operated. Alternatively, instead of a battery, the communication terminal can be equipped with a rechargeable battery. In addition, FIG. 1 shows a computer 16 that is connected to the switching center 10 via a hard-wired connection 22, for example a LAN connection (local area network). The wireless connection 20 transmits audio signals, i.e. the spoken contributions of the participants, from the participant units 12 or the chairperson unit 14, via the switching center 10, to the other participant units 12 and the chairperson unit 14. In addition, the wireless connection 20 is used to transmit data between the participant units 12, the chairperson unit 14, and the switching center 10. For example, the transmitted data are the spoken messages of the participants. In addition, the wireless connection 20 serves to transmit control data between the participant units 12, the chairperson unit 14, and the switching center 10. For example, by means of the communication protocol, the switching center 1Q sends messages to the participant units 12 and the chairperson unit 14 that cause the communication terminals to switch into a standby mode (sleep mode) as their operating mode. To this end, a status bit is provided in the protocol header in the communications protocol; this status bit indicates whether the communication terminal should be in the rest state (standby mode, sleep mode) or in the normal mode. In the standby mode of the participant units 12 and the chairperson unit 14, their input units and/or the output units and the processing units—which belong to the participant units 12 and the chairperson unit 14 and are required for executing the input and output—are nonfunctional, thus assuring a power-saving operation and reducing the power consumption of the battery or rechargeable battery. In this standby mode, the participant units 12 and the chairperson unit 14 perform checks at regular intervals to find out whether or not they should remain in this power-saving operating mode. This takes place in that the communication terminals read the status bit provided for this in the protocol header. In order to wake up the participant units 12 and the chairperson unit 14, i.e. in order to switch them from the standby mode into the normal operating mode, the switching center 10 uses the communications protocol to transmit a message to the participant units 12 and/or the chairperson unit 14 via the wireless connection 20. This message prompts the communication terminals to switch from the standby mode into the normal mode. In this context, the normal mode is the operating state in which the functionality of the conference system is available to the participant, in particular the input units and the output units of the participant units 12 and of the chairperson unit 14 are activated. The chairperson or another authorized user of the conference system can carry out the control of the operating state of the participant units 12 and/or of the chairperson unit 14 either directly at the switching center 10 or remotely via the computer 16 connected to the switching center 10. In the preferred exemplary embodiment, the switching center 10 and the computer 16 connected to the switching center 10 each provide the user of the conference system with a possibility of furnishing input. The switching center in the preferred exemplary embodiment has two buttons; actuating the first button gives a user input that switches the connected participant units 12 and the chairperson unit 14 into a power-saving standby mode. Actuating the second button gives a user input that wakes up the connected participant units 12 and the chairperson unit 14, switching them from the power-saving standby mode into the normal operating mode. Finally, the switching center 10, the participant units 12, and the chairperson unit 14 are embodied for carrying out the method described in conjunction with FIG. 3; in particular, these units have processing units required for this, which are embodied in the form of microprocessors and memory units.

FIG. 2 shows a phase diagram of the participant units and/or the chairperson unit of the preferred exemplary embodiment; the phase diagram includes two operating modes. In the standby mode 30, the participant units and/or the chairperson unit are in a power-saving mode in which some of their functions and therefore the technical units required for performing these functions are switched off. By means of a mode change 34, initiated by a message from the switching center, the operating mode is switched from the standby mode 30 to the normal mode 32. A repeat mode change 36 triggers the switch from the normal operating mode 32 into the standby mode 30.

FIG. 3 is a flowchart of the method of the preferred exemplary embodiment. The method begins with the start 40. In the first method step 42, either a user input is carried out by a user of the communication system directly at the switching center or on the computer connected to it, for example by actuating a button, or a participant unit and/or the chairperson unit sends the switching center a message via the wireless connection that a user input has been carried out. In the first variant, the user input means that the other participant units or the chairperson unit should be switched from the current, power-saving standby mode into the normal operating mode. In a second variant, the user input means that the other participant units or the chairperson unit should be switched from the current, normal operating mode into the power-saving standby mode. In the second variant, when the user input occurs in a participant terminal, this assures that this transition into the standby mode is prompted only by authorized users. This is assured by requiring the input of an encoding key combination into the communication terminal. Preferably, this transition of the operating mode is prompted only by the chairperson unit. In the second method step 44, the switching center, prompted by the received message or by the user input carried out at the switching center or on a computer, transmits a message to the participant units and/or to the chairperson unit, including the communication terminal that sent the message, in order to correspondingly switch the participant units and/or the chairperson unit into the desired standby mode and/or normal mode. The end step 46 terminates the process.

Preferably, the above-described method is used in wireless conference systems in accordance with the above-described exemplary embodiment. However, the method is not limited to wireless communications systems and can, in particular, also be used in hard-wired communications systems, nor is the method limited to conference systems, but can instead be used universally in communications systems.

What is claimed is:

1. A method for a power-saving operation of communication terminals (12, 14) in a communication system, in particular in a wireless communications system,
wherein a switching center (10) of the communications system, as a function of a user input, prompts a change of an operating state of the communication terminals (12, 14) of the communication system, which operating state is characterized by the power consumption.

2. The method as recited in claim 1,
wherein the switching center (10) switches the communication terminals (12, 14) into a power-saving standby mode.

3. The method as recited in claim 1,
wherein the switching center (10) switches the communication terminals (12, 14) from a power-saving standby mode (30) into a normal operating mode (32).

4. The method as recited in claim 1,
wherein the user input occurs in the switching center (10) or on a computer (16) connected to the switching center (10).

5. The method as recited in claim 1,
wherein the user input takes place in a communication terminal (12, 14), whereupon the communication terminal (12, 14) sends the switching center (10) a message that prompts the switching center (10) to change an operating state of the other communication terminals (12, 14), which operating state is characterized by the power consumption.

6. The method as recited in claim 5,
wherein the message that the communication terminal (12, 14) transmits to the switching center (10) prompts the switching center (10) to switch the other communication terminals (12, 14) into a power-saving standby mode (30).

7. The method as recited in claim 6,
wherein the switching center (10), based on the received message, transmits another message to the other communication terminals (12, 14), which then switch into the power-saving standby mode (30).

8. The method as recited in claim 5,
wherein the message that the communication terminal (12, 14) transmits to the switching center (10) prompts the switching center (10) to switch the other communication terminals (12, 14) from a power-saving standby mode (30) into a normal operating mode (32).

9. The method as recited in claim 8,
wherein the switching center (10), based on the received message, transmits another message to the other communication terminals (12, 14), which then switch from the power-saving standby mode (30) into the normal operating mode (32).

10. The method as recited in claim 2,
wherein input units and/or output units of the communication terminals (12, 14) are nonfunctional in the power-saving standby mode (30).

11. A switching center (10), in particular equipped with means for carrying out the method as recited in claim 1,
wherein the switching center (10) is configured so that the switching center (10), as a function of a user input, prompts a change of an operating state of the communication terminals (12, 14) of the communication system, which operating state is characterized by the power consumption.

12. A communication terminal (12, 14), in particular equipped with means for carrying out the method as recited in claim 1,
wherein the communication terminal (12, 14) is configured so that as a function of user inputs into the communication terminal (12, 14), the communication terminal (12, 14) sends the switching center (10) messages that are suitable for prompting the switching center (10) to change an operating state of other communication terminals (12, 14), which operating state is characterized by the power consumption.

13. A use of a switching center (10) as recited in claim 11 and a communication terminal (12, 14) in a conference system, in particular in a wireless conference system,
wherein the communication terminal (12, 14) is embodied in the form of a participant unit and/or a chairperson unit.
